(19) United States
(12) Patent Application Publication
(10) Pub. No.: US 2006/0164785 A1
(43) Pub. Date: Jul. 27, 2006

(54) Electrostatic bonding chuck with integrated radio frequency electrode and thermostatic means

(75) Inventor: Yvon Pellegrin, Montpellier (FR)

Correspondence Address: EGBERT LAW OFFICES, 412 MAIN STREET, 7TH FLOOR, HOUSTON, TX, 77002, US

(73) Assignee: SEMCO ENGINEERING S.A., MONTPELLIER CEDEX (FR)

(21) Appl. No.: 10/544,516

(22) PCT Filed: Feb. 5, 2004
(86) PCT No.: PCT/EP04/50083

§ 371 Date: Mar. 24, 2006

(30) Foreign Application Priority Data
Feb. 5, 2003 (FR) FR0301323

(51) Int. Cl. H01T 23/00

(52) U.S. Cl. 361/234

(57) ABSTRACT

The invention concerns an electrostatic chuck (250) comprising an upper ceramic (205) bearing the substrate (200) to be treated and a lower ceramic (215) bearing heating elements (225) and radio frequency electrodes (220), said ceramics being permanently bonded together. Said ceramics are preferably bonded together by heated glass and the lower ceramic is fixedly assembled to a pedestal, for example through a soldered bonding.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

This invention concerns an electrostatic maintenance chuck with radio frequency electrode and built-in thermostatic components. It applies but is not limited to the fabrication of electronic components.

### BACKGROUND OF THE INVENTION

In order to achieve the metallization of silicon substrates used for the fabrication of electronic components, for example MOS (Metal Oxide Semiconductor) transistors, aluminum is deposited using PVD (Physical Vapor Deposition). The sought-after optimization of electric performances connected to the gradual decrease of the component sizes, the problems of connection welds and the execution of connecting wells leads the industry to using copper in place of aluminum for the metallization step. It is to be noted that copper is deposited mainly through an electroplating reaction in liquid medium that requires prior depositing of a copper base layer using PVD.

This base layer has highly critical characteristics. This invention, through its specific properties, contributes to achieving these characteristics.

FIG. 1 shows a chuck according to the prior art. It shows a substrate 100, for example a silicon wafer, that rests on an electrostatic chuck 110 provided with a central opening 120 and laterally held by hooks 130. The chuck itself 110 rests on a support 140 (or base) that contains cooling circuits 150, heaters 160. The chuck has a central opening 180, in the axis of central opening 120 of chuck 110. Through these openings, gas 190 is injected, for example helium or argon, promoting heat transfers between support 140, chuck 110 and substrate 100. RF 170 radio frequency electrodes, if any, are placed on support 140.

The presence of two gaps between, on one hand, substrate 100 and electrostatic chuck 110 and, on the other hand, between electrostatic chuck 110 and support 140, implies problems of temperature rise, temperature control (each gap causes a temperature difference of several tenths of degrees) and temperature uniformity over the surface of substrate 100.

The purpose of this invention is to eliminate these disadvantages.

### BRIEF SUMMARY OF THE INVENTION

To that effect, this invention concerns an electrostatic chuck characterized in that it includes:
an upper ceramic suitable to bear the substrate to be treated, and
a lower ceramic bearing heating elements and radio frequency electrodes, said ceramics being bonded together in a durable manner.

Because of these arrangements, only one gap is present and temperature control and uniformity are made easier and safer and temperature rises quicker. The radio frequency electrodes make it possible to modulate the plasma around the substrate to be treated.

According to special characteristics, the ceramics are bonded together with heated glass. Because of these arrangements, the bonding is isolating and heavy duty and the stresses and arrangements relating to RF electrode isolation can be reduced as the base can be grounded.

According to special characteristics, the electrostatic chuck includes a base bearing cooling elements, with the lower ceramic attached to the base in a durable manner.

According to special characteristics, the lower ceramic is attached to the base through a brazed connection.

According to special characteristics, the brazing of the brazed connection is made with indium.

According to special characteristics, the lower ceramic is attached to the base by bonding.

According to special characteristics, bonding is silver-based.

Because of each of these arrangements, the lower ceramic and base have a good heat bond and the RF electrodes are isolated from the base.

According to special characteristics, the lower ceramic has cooling elements.

According to special characteristics, the lower ceramic is borne by lateral supports attached in a durable manner to said lower ceramic.

### BRIEF DESCRIPTION OF THE SEVERAL VIEWS OF THE DRAWINGS

Other advantages, goals and characteristics will become clear from the description below, made in an explanatory but not at all limiting manner based on the attached drawing where:

FIG. 1 is a schematic cross-section of a chuck according to the prior art,

FIG. 2 is a schematic cross-section of a first embodiment of an electrostatic chuck according to this invention,

FIG. 3 is a schematic cross-section of a second embodiment of an electrostatic chuck according to this invention,

FIG. 4 is a cross-section of the electrostatic chuck shown in FIG. 2, and

FIG. 5 is a perspective view of the electrostatic chuck shown in FIG. 2.

### DETAILED DESCRIPTION OF THE INVENTION

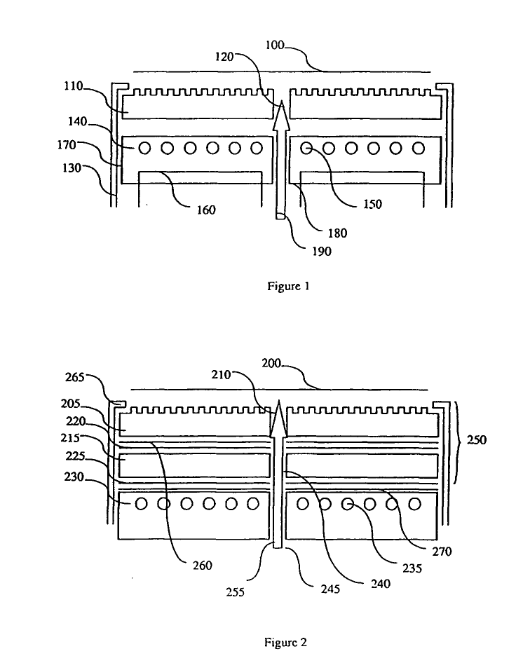

The components shown in FIG. 1 have already been presented above.

FIG. 2 shows an electrostatic chuck 250 according to one embodiment of this invention. It shows a substrate (wafer) 200 resting on an upper ceramic 205 of electrostatic chuck 250, provided with a gas inlet central opening 210. Upper ceramic 205 is bonded using bonding agent 260 to a lower ceramic 215 that bears radio frequency RF electrodes 220 and heating elements 225. The lower ceramic 215 is itself attached in a durable manner to a support 230 (or base) that contains cooling circuits 235. The lower ceramic 215 has a gas inlet central opening 240 in the axis of the gas inlet central opening 210 on upper ceramic 205. The base 230 has a gas inlet central opening 245 in the axis of gas inlet central openings 210 and 240 on upper and lower ceramics.

Through these gas inlet central openings 210, 240 and 245, gas 255 is injected, for example helium or argon, facilitating heat transfers between the upper ceramic 205 and the substrate 200.

Thus, according to this invention, there is only one gap between substrate 200 and each of the heating, cooling or radiation elements, which reduces constraints with regard to temperature rise, temperature control (each gap causes a temperature difference of 30 cl) and temperature uniformity over the surface of the substrate 200.

Under an especially interesting embodiment, the bonding agent 260 is a bonding agent made of glass that is applied at a temperature where glass is liquid and malleable. The bonding also provides electric isolation between both ceramics. RF 220 radio frequency electrodes are, for example, flat electrodes positioned on the upper face of the lower ceramic 215. The heating elements 225 are, for example, flat electrodes positioned on the lower face of the lower ceramic 215.

The assembling between lower ceramic 215 and base 230 is for example achieved through a brazed connection using indium brazing 270 for good heat conduction bond. Under an alternative embodiment, the assembling between the lower ceramic 215 and the base 230 is achieved through bonding, for example with a silver-based bonding agent 270. The pins 265 make it possible to handle the wafers.

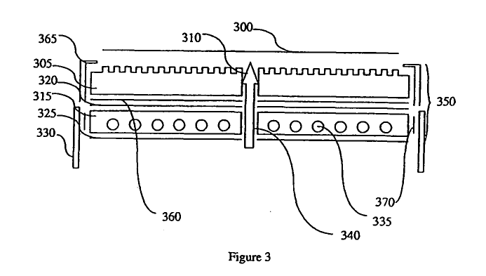

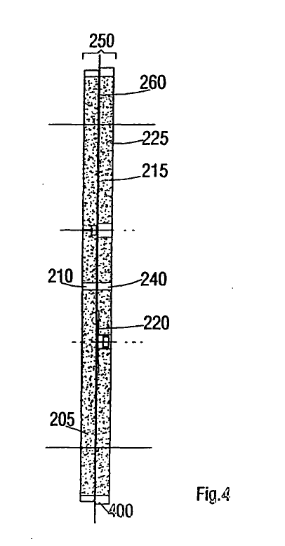

FIG. 3 shows an electrostatic chuck 350 according to an embodiment of this invention. It shows a substrate (wafer) 300 resting on an upper ceramic 305 of the electrostatic chuck 350, provided with a gas inlet central opening 310. The upper ceramic 305 is bonded, using bonding agent 360, to a lower ceramic 315 that bears RF radio frequency electrodes 320, heating elements 325 and cooling circuits 335. The lower ceramic 315 is itself attached in a durable manner, through its lateral faces, to a support 330. The lower ceramic 315 has a gas inlet central opening 340 in the axis of the gas inlet central opening 310 on the upper ceramic 305.

Through these gas inlet central openings 310 and 340, gas 350 is injected, for example helium or argon, facilitating heat transfers between the upper ceramic 305 and the substrate 300. Thus, according to this invention, there is only one gap between substrate 300 and each of the heating, cooling or radiation elements, which reduces constraints with regard to temperature rise, temperature control and temperature uniformity over the surface of the substrate 300.

Under an especially interesting embodiment, the bonding agent 360 is a bonding agent made of glass that is applied at a temperature where glass is liquid and malleable. The bonding also provides electric isolation between both ceramics. RF radio frequency electrodes 320 are, for example, flat electrodes positioned on the upper face of the lower ceramic 315. The heating elements 325 are, for example, flat electrodes positioned on the lower face of the lower ceramic 315.

The assembling between lower ceramic 315 and base 330 is for example achieved through a brazed connection using indium brazing 370 for good heat conduction bond. Under an alternative embodiment, the assembly between the lower ceramic 315 and the base 330 is achieved through bonding, for example with a silver-based bonding agent 370.

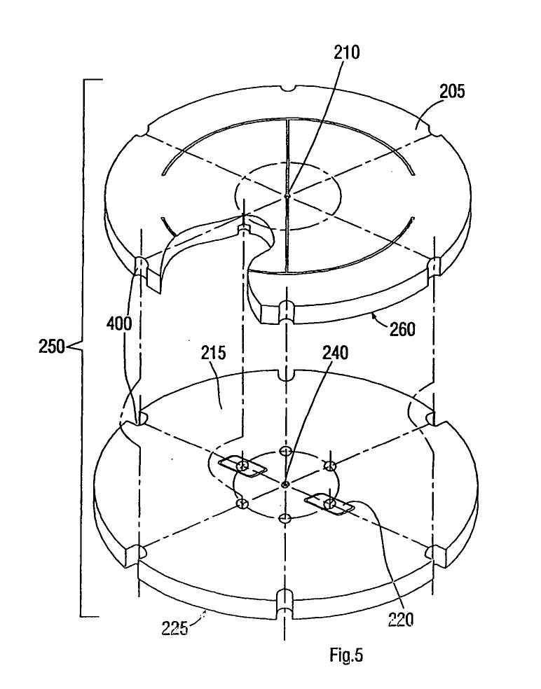

FIG. 4 shows a cross-section and FIG. 5 a perspective view of the electrostatic chuck shown in FIG. 2. In FIG. 5, both ceramics 205 and 215 are separated for explanatory purposes.

FIGS. 4 and 5 show electrostatic chuck 250 that comprises the upper ceramic 205 and the lower ceramic 215, central openings 210 and 240, the layer of bonding agent 260, RF radio frequency electrodes 220 and heating elements 225. Six lateral cylindrical recesses 400 parallel to the ceramic axis are made at regular intervals on the ceramics to receive pins 365 used to handle the wafers.

1. Electrostatic chuck, comprising:
an upper ceramic bearing a substrate to be treated,
a lower ceramic bearing heating elements, and
radio frequency electrodes, the ceramics being bonded together in a durable manner.

2. Chuck according to claim 1, wherein the ceramics are bonded together with heated glass.

3. Chuck according to claim 1 further comprising:
a base bearing cooling elements, said lower ceramic being attached to the base in a durable manner.

4. Chuck according to claim 3, wherein said lower ceramic is attached to the base through a brazed connection.

5. Chuck according to claim 4, wherein said brazed connection is comprised of indium.

6. Chuck according to claim 3, wherein said lower ceramic is attached to the base through bonding.

7. Chuck according to claim 6, wherein bonding of the lower ceramic onto the base is comprised of silver.

8. Chuck according to claim 1, wherein said lower ceramic contains cooling elements.

9. Chuck according to the claim 1, wherein said lower ceramic is carried by lateral supports attached in a durable manner to said lower ceramic.

10. Chuck according to claim 1 wherein each of the upper and lower ceramics is run through by gas inlet opening.
